(19) United States
(12) Patent Application Publication
(10) Pub. No.: US 2007/0057801 A1
(43) Pub. Date: Mar. 15, 2007

(54) MONITOR FOR PLANT ENVIRONMENTAL CONDITIONS

(75) Inventor: Christopher L. Hawker, Santa Cruz, CA (US)

Correspondence Address: STANDLEY LAW GROUP LLP, 495 METRO PLACE SOUTH, SUITE 210, DUBLIN, OH, 43017, US

(73) Assignee: TRIDENT DESIGN LLC, Santa Cruz, CA (US)

(21) Appl. No.: 11/469,415

(22) Filed: Aug. 31, 2006

Related U.S. Application Data
(60) Provisional application No. 60/713,036, filed on Aug. 31, 2005.

(51) Int. Cl. G08B 21/00

(52) U.S. Cl. 340/604

(57) ABSTRACT

A device for monitoring at least one environmental condition of a plant or any other type of vegetation. Another exemplary embodiment is a method for providing a visible indication of at least one environmental conditional of a plant. In one exemplary embodiment, a device may emit light to provide notice of at least one environmental condition of a plant. An exemplary embodiment of the device may include means for controlling and/or adjusting the light output. As a result, an exemplary embodiment of the device may provide a desirable and suitable visible indication of at least one environmental condition of a plant.

This application claims the benefit of U.S. Provisional Application No. 60/713,036, filed Aug. 31, 2005, which is hereby incorporated by reference in its entirety.

### BACKGROUND AND SUMMARY OF THE INVENTION

The present invention relates generally to a device and method for monitoring at least one environmental condition of a plant or any other type of vegetation.

A number of environmental conditions affect the growth and health of plants. For instance, the makeup of the soil (e.g., mineral content, fertilizer content, pH level, and other soil conditions), the moisture level of the soil, and the available light are among the primary conditions that determine whether a plant will thrive of perish. Each plant prefers a particular set of conditions for growth and sustained life. However, not all plants desire the same conditions. For instance, some plants may prefer acidic soil, whereas others grow better in alkaline soil. Certain plants may desire arid soil, which is in contrast to other varieties of plants that need moist or wet soil. In addition, some plants prefer shade, but other plants require sunlight in order to grow.

It is often difficult or impractical to accurately monitor the environmental conditions of a plant. For instance, the makeup or moisture content of the soil may not be visually discernible. Also, it may be difficult to account for the amount of sunlight that a plant receives. Such difficulties may impact the care of the plant. For instance, failure to respond appropriately and in a timely manner to changing environmental conditions may have negative consequences on the health of the plant. As a result, there is a need for a device and method for monitoring at least one environmental condition of a plant.

One exemplary embodiment of the present invention is a device that is adapted to provide a visible indication of at least one environmental condition of a plant. Another exemplary embodiment of the present invention is a method for providing a visible indication of at least one environmental conditional of a plant. In one exemplary embodiment, a device may emit light to provide notice of at least one environmental condition of a plant. An exemplary embodiment of the device may include means for controlling and/or adjusting the light output. As a result, an exemplary embodiment of the device may provide a desirable and suitable visible indication of at least one environmental condition of a plant.

In addition to the novel features and advantages mentioned above, other features and advantages of the present invention will be readily apparent from the following descriptions of the drawings and exemplary embodiments.

### BRIEF DESCRIPTION OF THE DRAWINGS

FIG. 1 is a front side elevation view of an exemplary embodiment of a device of the present invention.

FIG. 2 is a perspective view of an exemplary embodiment of a device of the present invention.

FIG. 3 is opposing side elevation views of an exemplary embodiment of a device of the present invention.

FIG. 4 is a fragmented view of an exemplary embodiment of a device of the present invention.

FIG. 5 is another fragmented view of the device of FIG. 4.

FIG. 6 is another fragmented view of the device of FIG. 4.

FIG. 7 is another fragmented view of the device of FIG. 4.

FIG. 8 is a side elevation view of an exemplary embodiment of a device of the present invention.

FIG. 9 is a perspective view of the device of FIG. 8.

FIG. 10 shows various views of the device of FIG. 8.

FIG. 11 is a schematic diagram of an exemplary embodiment of circuitry of a device of the present invention.

FIG. 12 is a schematic diagram of an exemplary embodiment of a circuitry of a device of the present invention.

### DETAILED DESCRIPTION OF EXEMPLARY EMBODIMENT(S)

One exemplary embodiment of the present invention is a device that is adapted to monitor at least one environmental condition, particularly for use with a plant or any other type of vegetation. Another exemplary embodiment of the present invention is a method for monitoring at least one environmental condition, such as for a plant or any other type of vegetation. Examples of plants include, but are not limited to, trees, shrubs, herbs, flowers, crops, vines, and other varieties. Based on the present specification, it should be recognized that an exemplary device of the present invention may also be used to monitor at least one environmental condition for other purposes.

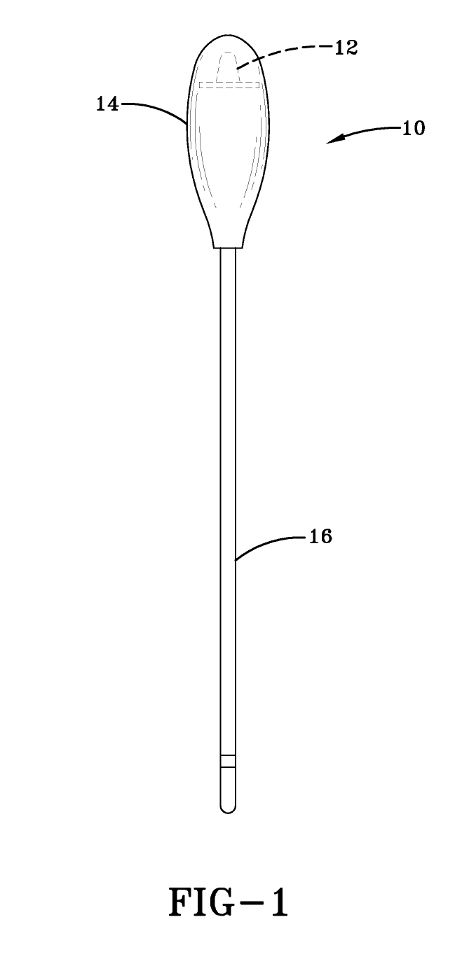

FIG. 1 shows an example of the present invention. In this example, device 10 may be adapted to monitor the moisture level of soil or any other wet or moist material.

Although it is not intended to limit the present invention to the exemplary embodiment shown in FIG. 1, the present invention will be described primarily with reference to device 10. Device 10 includes a light source 12, which may be substantially enclosed within a diffuser or translucent enclosure 14. An example of light source 12 is a light-emitting diode (i.e., LED), which may provide a desirable operational life. Light source 12 may be any desired color. In an exemplary embodiment of the present invention, light source 12 may be a desired color (e.g., green, brown, or any other desired color) that is sufficiently visible and optionally goes well with the colors of a plant and its surroundings. In addition, diffuser or translucent enclosure 14 is preferably adapted to distribute or soften the light emitted by light source 12. By distributing or softening the light emitted by light source 12, an exemplary embodiment of device 10 may provide a visible indication of at least one environmental condition of a plant. For instance, one exemplary embodiment of diffuser or translucent enclosure 14 may glow or otherwise transmit light when light source 12 emits light, thereby making it visible from all angles around the sides of device 10 (i.e., 360-degree visibility around the sides of device 10). Optionally, a portion (e.g., a top portion or a bottom portion) or the entire body (i.e., the top and bottom portions) of diffuser or translucent enclosure 14 may glow or otherwise transmit light when light source 12 emits light. Such an exemplary embodiment may be more readily visible from substantially more angles as compared to a light source that emits light in only a limited direction, particularly during the daytime. Optionally, certain exemplary embodiments of the present invention may also provide a less obtrusive visual indication as compared to a unidirectional light source as a result of the distribution or softening of light provided by the diffuser or translucent enclosure of the present invention.

Diffuser or translucent enclosure 14 may have any suitable structure and characteristics for distributing or softening the light emitted by light source 12. In one exemplary embodiment of the present invention, diffuser or translucent enclosure 14 may be tinted (e.g., green, brown, or any other desired color) such that device 10 transmits a desirable color of light. In other words, the characteristics of diffuser or translucent enclosure 14 may optionally have characteristics that help it to fit with the environment (e.g., match the colors of the plant or surrounding environment) such that device 10 is less obtrusive when device 10 is emitting light as well as when it is not emitting light. Another exemplary embodiment of a diffuser or translucent enclosure may have a plurality of angled surfaces to facilitate the distribution of light output.

An exemplary embodiment of device 10 may include a probe 16. In this example, probe 16 may extend from diffuser or translucent enclosure 14. Probe 16 of this embodiment may be inserted a desired depth into the soil in order to detect the moisture level. In this exemplary embodiment, probe 16 may be inserted relatively deeply into the soil for a plant that requires dry soil, and probe 16 may be inserted a desired minimal distance into the soil for a plant that requires moist or wet soil. Of course, it should be recognized that other variations of use are also possible, such as for example, depending on the circuitry employed by an exemplary embodiment of a device.

Device 10 may include any suitable circuit for detecting moisture or a lack of moisture. One example is a circuit (e.g., a millivolt meter circuit) that generates a current when sufficient moisture is present in the soil. Another example is a circuit (e.g., a millivolt meter circuit) that generates a current when the soil is sufficiently dry.

In the embodiment shown in FIG. 1, a portion of the circuitry is substantially enclosed within diffuser or translucent enclosure 14. Such as in this example, the circuitry (e.g., a wire) may extend out of diffuser or translucent enclosure 14 and down probe 16. When probe 16 is inserted into the soil, the circuitry may be adapted to generate a current when it detects a sufficient amount of moisture of a sufficient level of dryness.

In the example of FIG. 1, the circuitry is adapted to cause light source 12 to flash when the soil reaches a certain level of dryness. In other embodiments of the present invention, the circuitry may be selected to achieve any desired functionality of light source 12. For instance, the circuitry may be designed such that light source 12: is constantly on when the soil reaches a certain level of dryness or wetness; is turned off when the soil reaches a certain level of dryness or wetness; changes colors when the soil reaches a certain level of dryness or wetness; flashes when the soil reaches a certain level of dryness or wetness; or is in any other desired mode when the soil reaches a certain level of dryness or wetness. As a result, by recognizing the status of light source 12, a user may determine the moisture level in the soil and water the plant, if necessary.

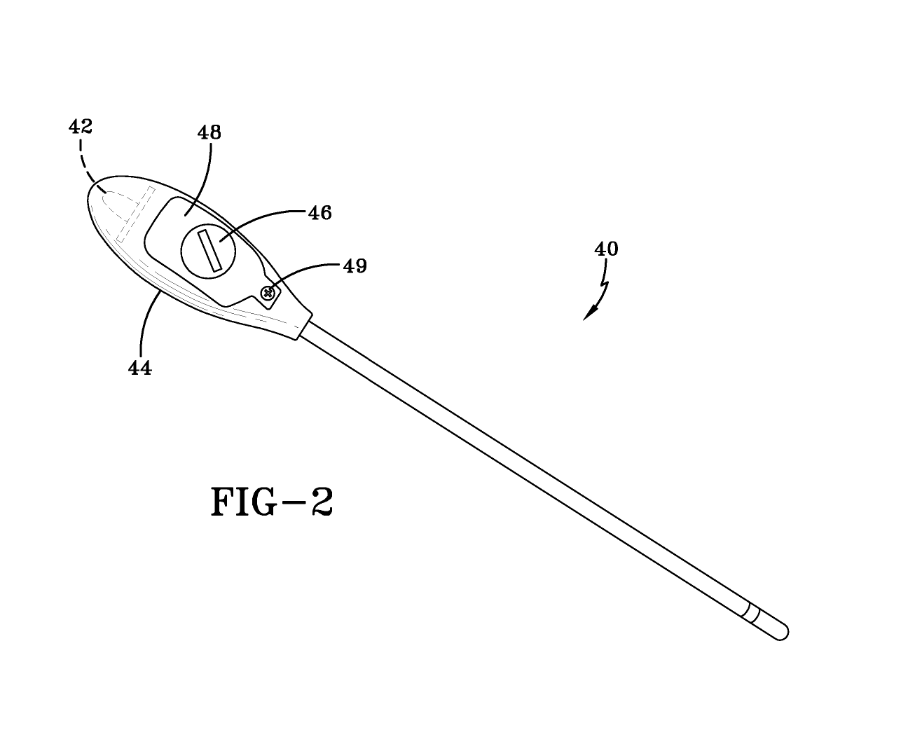

FIG. 2 shows another example of a device for detecting the moisture level of the soil. This embodiment of device 40 includes a light source 42 that is substantially enclosed within a diffuser or translucent enclosure 44. In addition, the circuitry of device 40 includes an on-off switch 46. In this example, switch 46 is a rotary switch that may be rotated between an “on” position and an “off” position to move at least one electrical contact associated with switch 46 into (i.e., “on” position) or out of (i.e., “off” position) electrical communication with a battery to control the operation of device 40. Other exemplary embodiments may use any other suitable type of switch. In this exemplary embodiment, switch 46 may be snapped into position on enclosure 44, whereby switch 46 may be connected to a battery door 48 that holds a battery in place. In this example, screw 49 may be unscrewed to enable removal of battery door 48, such as to allow replacement of a battery. Examples of batteries include watch batteries, hearing aid batteries, and other suitable types of batteries. It should be recognized that other exemplary embodiments of the present invention may use other types of batteries or other suitable power sources.

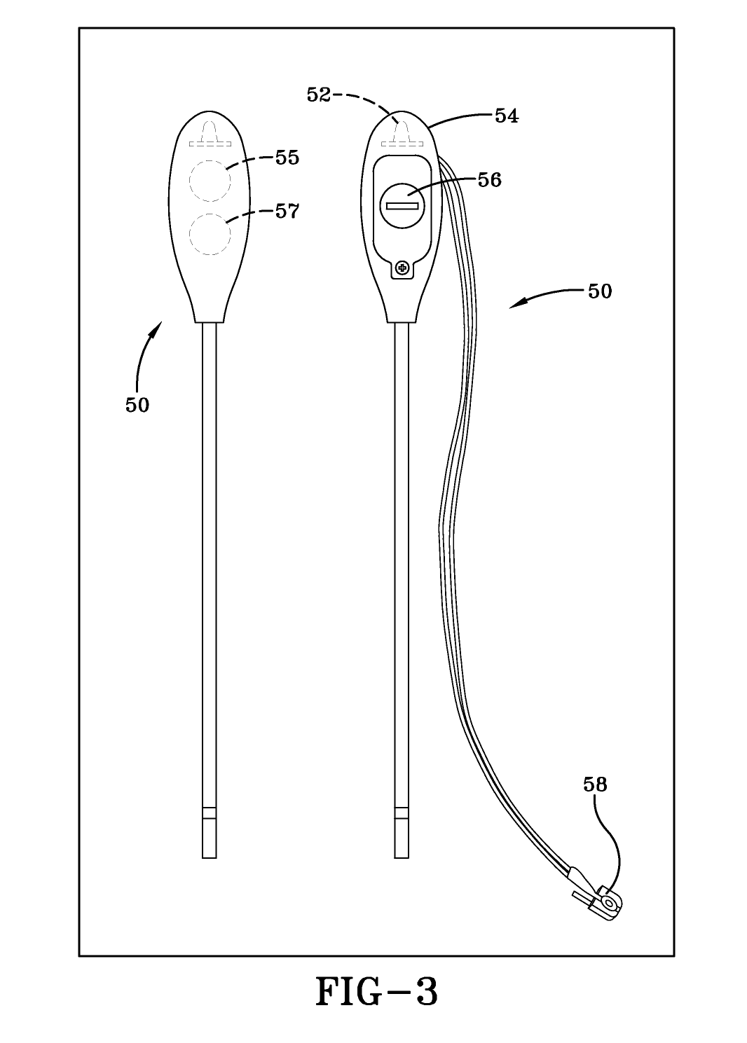

FIG. 3 shows another exemplary embodiment of a device of the present invention. The exemplary embodiment of device 50 also includes a light source 52 substantially enclosed within an enclosure 54 that is adapted to distribute or soften the light output. Similarly to the previous example, device 50 also includes an on-off switch 56. In this example, switch 56 is used in association with batteries 55 and 57 to control the operation of the circuit. Moreover, in this exemplary embodiment, the circuitry of device 50 includes an external adjustment component 58 for calibration purposes. In this example, the external adjustment component 58 is an adjustable resistor (i.e., a potentiometer). It should also be recognized that the circuitry may be calibrated during fabrication for some exemplary embodiments of the present invention. For example, a device may be configured at the factory for use with a particular type of plant or vegetation. Other embodiments of the present invention may use any other suitable adjustment component for achieving the desired calibration. Calibration may be useful, for example, to adjust to the moisture requirements of different types of plants. FIG. 3 shows an example in which the external adjustment component 58 extends away from enclosure 54. In other embodiments of the present invention, an adjustment component may be situated on or adjacent to the light enclosure or the probe.

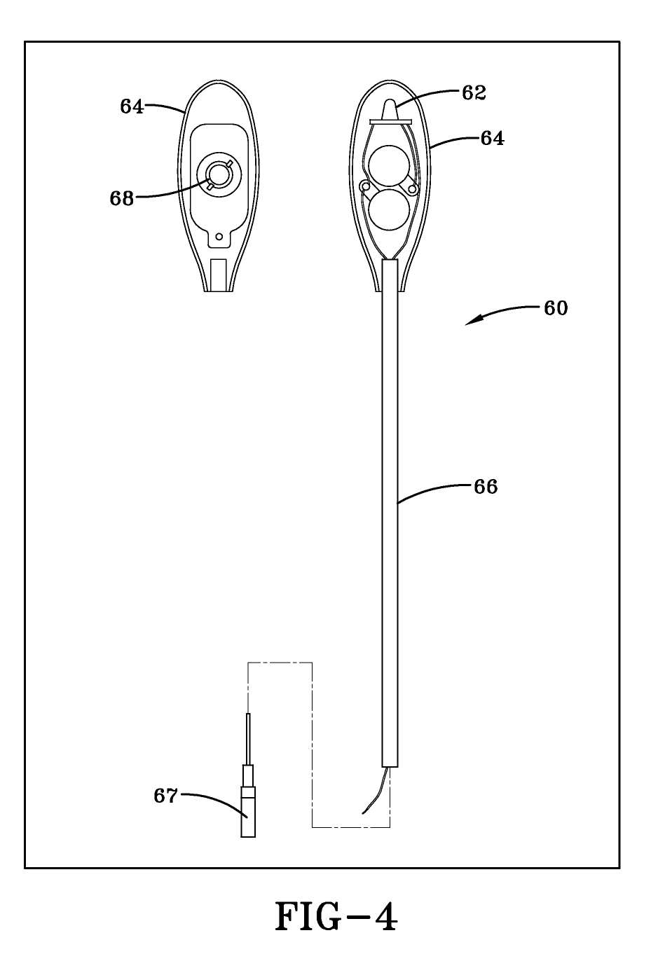

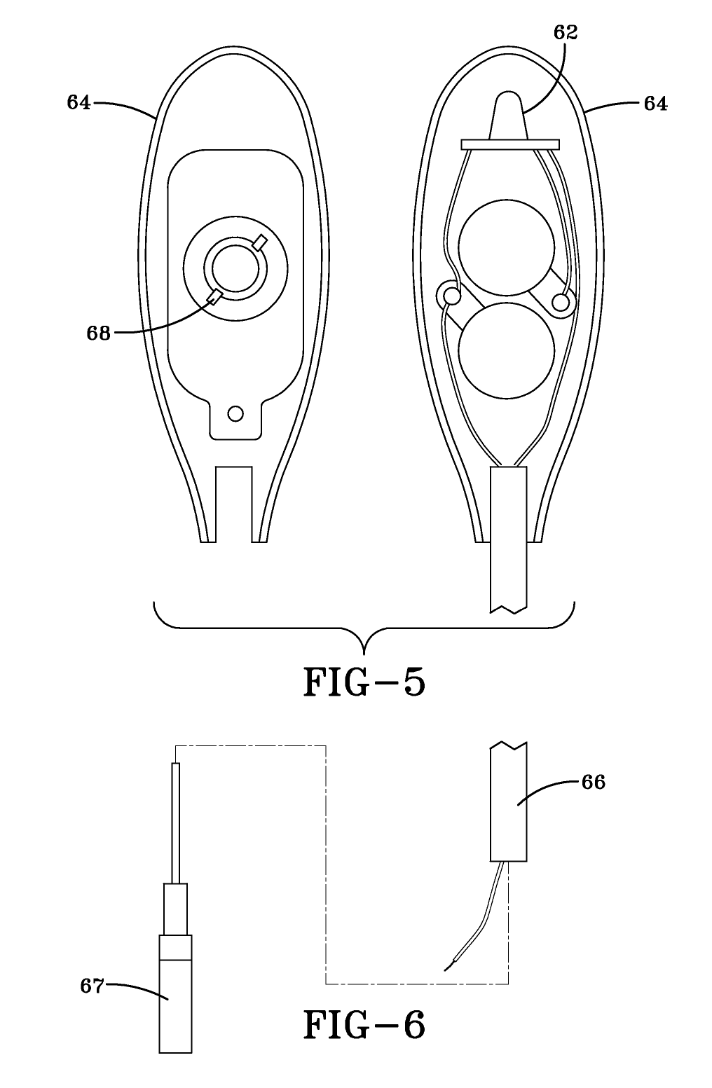

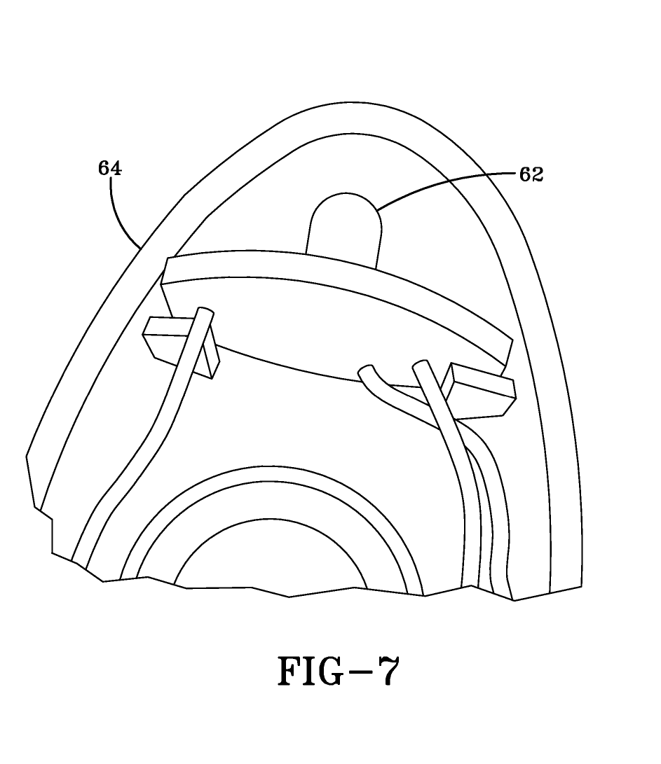

FIGS. 4 through 7 show another exemplary embodiment of the present invention. In this example, device 60 is comprised of a light source 62 located within an enclosure 64, which is separated into two halves in FIGS. 4 and 5. FIGS. 4 and 5 show that the on-off switch of this exemplary embodiment is comprised of an electric contact 68, which facilitates electrical communication with the batteries. In this example, device 60 also includes a stainless steel or brass probe 66 having a stainless steel or brass tip 67. In other exemplary embodiments of the present invention, the probe may be comprised of any suitable material. For enhanced resistance to corrosion, some suitable materials for a probe include, but are not limited to: aluminum brass 76/24 with 2% aluminum with some arsenic; admiralty brass 70/30 with 1% tin with some arsenic; and brass 70/30 with some arsenic.

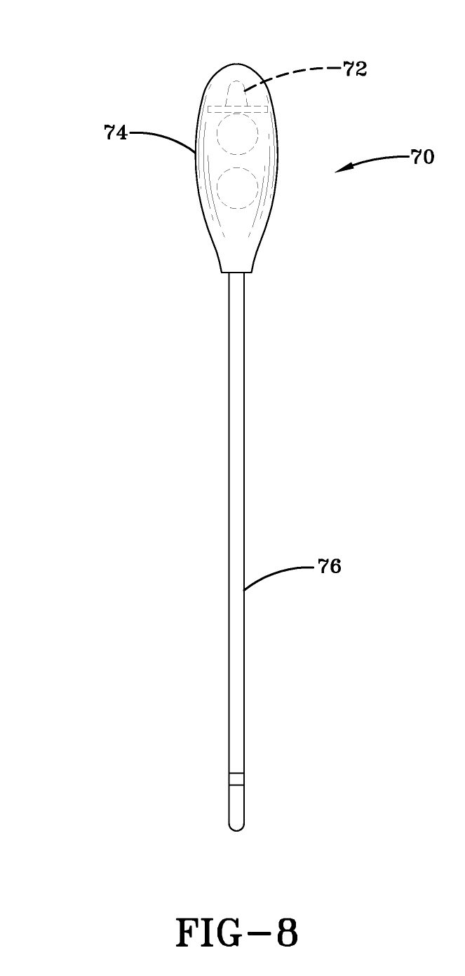

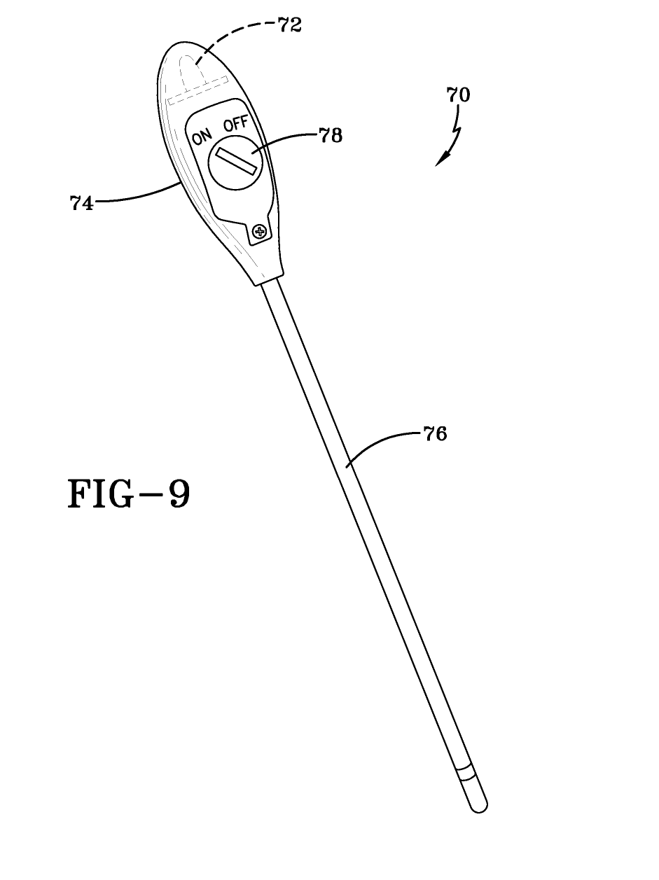

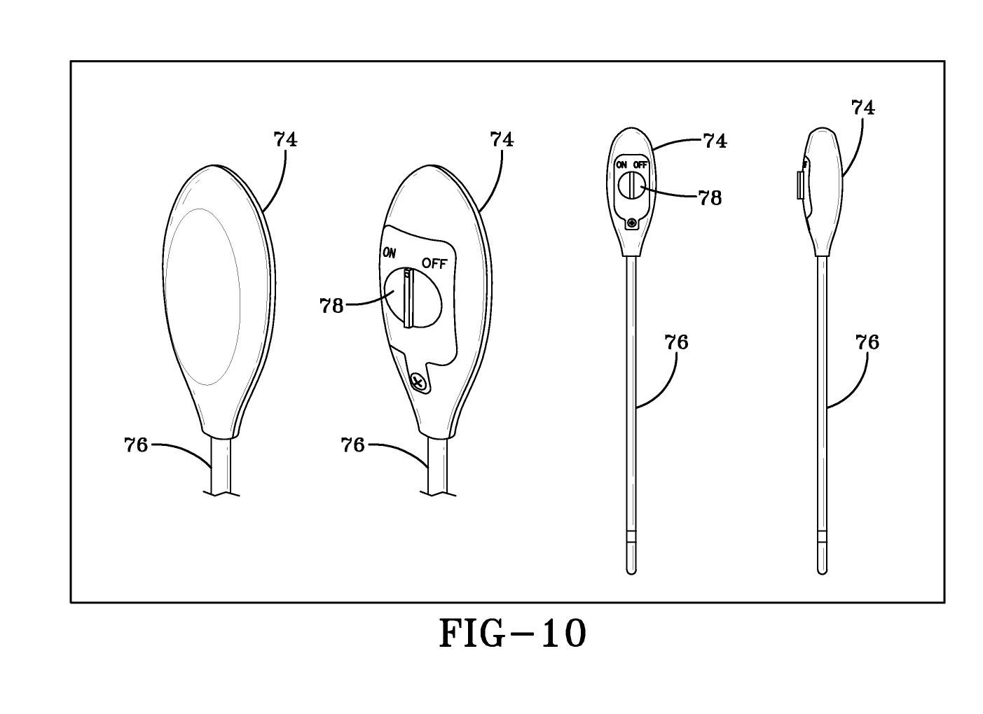

FIGS. 8 through 10 also show another example of the present invention. In this exemplary embodiment, device 70 is comprised of light source 72, enclosure 74, probe 76, and on-off switch 89. In this example, enclosure 74 may be green or any other desired color to assist with softening or distributing the light output.

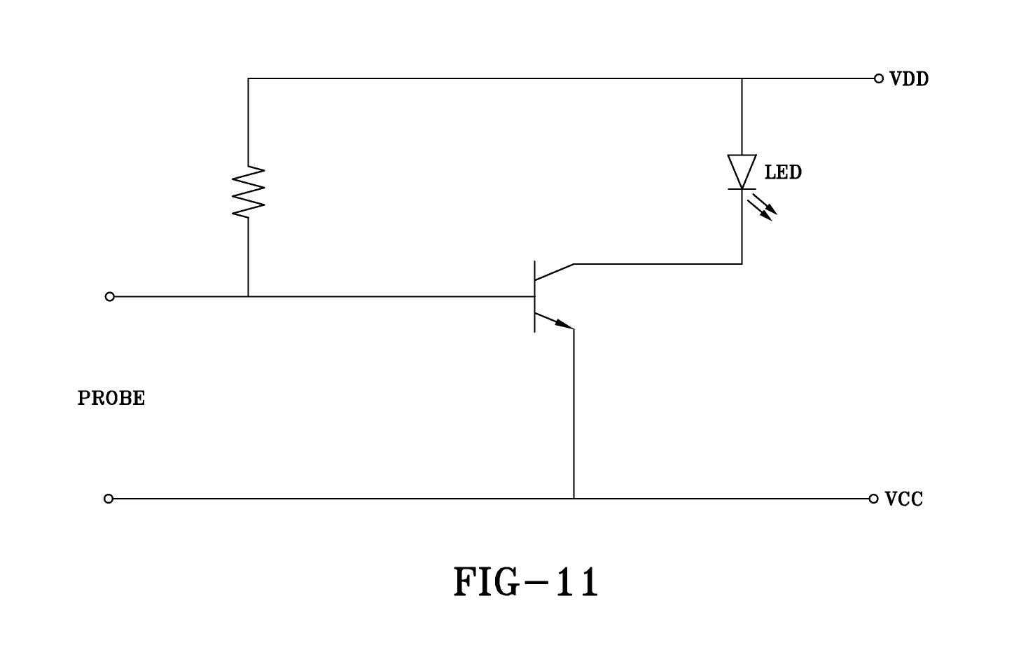

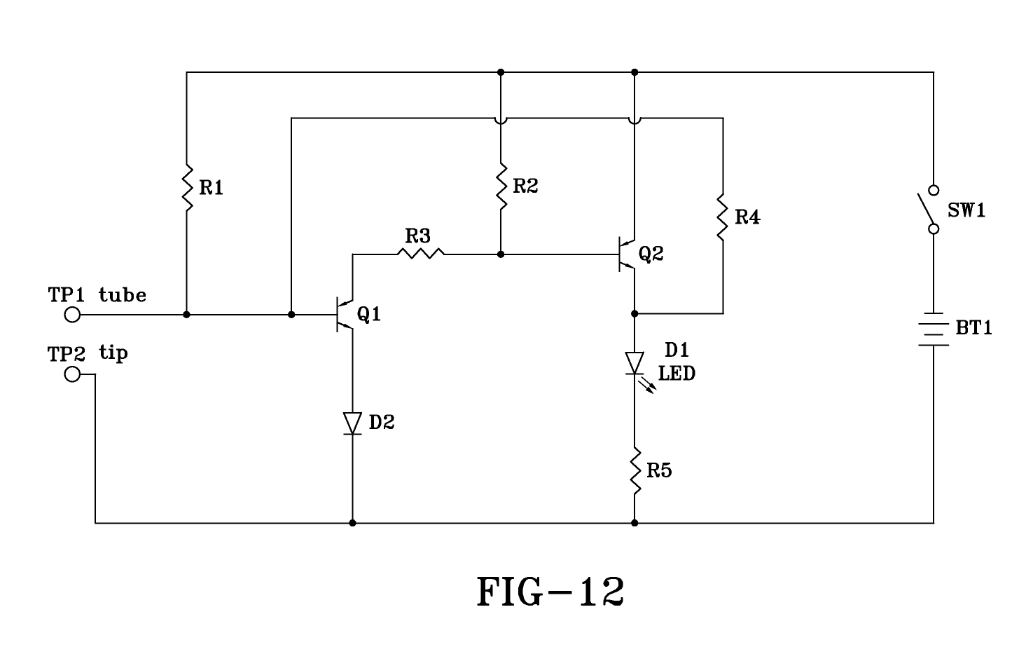

FIGS. 11 and 12 show examples of circuits for monitoring the moisture level. If desired, the resistor in the example of FIG. 11 may be replaced by an adjustable resistor to enable calibration of the device. Other circuits that are suitable for a particular application may be employed in other exemplary embodiments of the present invention.

A device for monitoring the moisture level of the soil around a plant is just one example of the present invention. Any desired circuitry may be selected to monitor any desired environmental condition(s). Other exemplary embodiments of the present invention include devices that are adapted to monitor one or more of the following environmental conditions including, but not limited to, the makeup of the soil (e.g., mineral content, fertilizer content, pH level, and other soil conditions), the moisture level of the soil, and the available light. For instance, an exemplary embodiment of the present invention may include a photo sensor circuit.

It should also be recognized that some embodiments of the present invention may not need to be inserted into soil in order to properly function. For example, some embodiments of the present invention may be situated anywhere sufficiently adjacent to the plant to perform its desired function. For instance, some exemplary embodiments of the present invention may be situated on the outside of a flower pot.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to affect the described invention. Many of those variations and modifications will provide the same result and fall within the spirit of the claimed invention. It is the intention, therefore, to limit the invention only as indicated by the scope of the claims.

What is claimed is:

1. A device comprising:
a light source; and
a diffuser substantially enclosing said light source;
wherein said device is adapted to emit light in response to an environmental condition of a plant.

2. The device of claim 1 wherein said light source is a light-emitting diode (LED).

3. The device of claim 1 wherein said diffuser is comprised of a translucent material.

4. The device of claim 1 wherein said diffuser is adapted to distribute light emitted by said device to provide 360-degree visibility.

5. The device of claim 1 further comprising a probe adapted to be inserted into soil adjacent to said plant.

6. The device of claim 1 further comprising:
a circuit adapted to detect said environmental condition of said plant;
wherein said circuit includes an on-off switch.

7. The device of claim 1 further comprising:
a circuit adapted to detect said environment condition of said plant;
wherein said circuit is adapted to be calibrated to adjust a level at which said environmental condition of said plant is detected.

8. The device of claim 1 wherein said environmental condition is a moisture level of soil.

9. The device of claim 1 wherein said environmental condition is selected from the group consisting of a moisture level of soil, a mineral content of soil, a fertilizer content of soil, a pH level of soil, and light.

10. A device comprising:
a light source; and
a translucent enclosure substantially enclosing said light source;
wherein said device is adapted to emit light in response to an environmental condition of a plant.

11. The device of claim 10 wherein said light source is a light-emitting diode (LED).

12. The device of claim 10 further comprising a probe adapted to be inserted into soil adjacent to said plant.

13. The device of claim 10 further comprising:
a circuit adapted to detect said environmental condition of said plant;
wherein said circuit includes an on-off switch.

14. The device of claim 10 further comprising:
a circuit adapted to detect said environment condition of said plant;
wherein said circuit is adapted to be calibrated to adjust a level at which said environmental condition of said plant is detected.

15. The device of claim 10 wherein said environmental condition is a moisture level of soil.

16. A device comprising:
a light source;
means for softening light emitted by said device; and
a probe adapted to be inserted in soil adjacent to a plant;
wherein said device is adapted to emit light in response to an environmental condition of a plant.

17. The device of claim 16 wherein said light source is a light-emitting diode (LED).

18. The device of claim 16 further comprising:
a circuit adapted to detect said environmental condition of said plant;
wherein said circuit includes an on-off switch.

19. The device of claim 16 further comprising:
a circuit adapted to detect said environment condition of said plant;
wherein said circuit is adapted to be calibrated to adjust a level at which said environmental condition of said plant is detected.

20. The device of claim 16 wherein said environmental condition is a moisture level of soil.
